(19) United States
(12) Patent Application Publication
(10) Pub. No.: US 2017/0004640 A1
(43) Pub. Date: Jan. 5, 2017

(54) DISPLAY DEVICE AND HEAD-UP DISPLAY

(71) Applicant: Au Optronics Corporation, Hsinchu (TW)

(72) Inventors: Hui Chu Ke, Hsinchu City (TW); Sheng-Wen Cheng, Hsinchu City (TW)

(21) Appl. No.: 14/860,719

(22) Filed: Sep. 22, 2015

(30) Foreign Application Priority Data
Jun. 30, 2015 (TW) 104121020

(51) Int. Cl. G06T 11/60; G02F 1/1343; G02B 27/01

(52) U.S. Cl. CPC G06T 11/60; G02B 27/0101; G02F 1/134309; G02B 2027/0118; G02F 2001/134345

(57) ABSTRACT

A display device includes a display panel, an image signal input module, and a sub-pixel rendering (SPR) means. The display panel includes a plurality of units. Each of the units includes at least 24 sub-pixels arranged in rows and columns. At least four first color sub-pixels, at least four second color sub-pixels, eight third color sub-pixels, and eight fourth color sub-pixels constitute each of the units. The image signal input module is configured to receive image signals. The SPR means is configured to perform a sub-pixel rendering process on the image signals thereby each of the sub-pixels of the display panel produces a performance value.

### CROSS-REFERENCE TO RELATED APPLICATION

This application claims the priority benefit of Taiwan application serial no. 104121020, filed on Jun. 30, 2015. The entirety of the above-mentioned patent application is hereby incorporated by reference herein and made a part of this specification.

### FIELD OF THE INVENTION

The invention relates to a display device; more particularly, the invention relates to a display device characterized by a favorable pixel aperture ratio, satisfactory transmittance, and high brightness and a head-up display having the display device.

### DESCRIPTION OF RELATED ART

A head-up display is commonly applied as an auxiliary flight instrument on an aircraft; at present, some vehicles are equipped with the head-up displays as well, so as to project images of car speed, rotation, engine coolant temperature, fuel consumption, and other conditions of the vehicles onto the windshields for the drivers to observe.

In general, the images displayed on the head-up display are usually simple and are generated at a distance from the drivers, and therefore human eyes cannot tell the difference in the resolution of the images. Compared with the image resolution required by other devices that display images, such as mobile phones and tablet PCs, the image resolution required by the head-up display is set to a lower standard. Nevertheless, in order for drivers to easily observe the images projected onto the windshields under the clear sky, the standard of brightness required by the head-up display is high in comparison with the standard of brightness required by other display devices. Hence, how to effectively increase the transmittance and the brightness of the display panel in the head-up display is one of the research topics in the pertinent field.

### SUMMARY OF THE INVENTION

The invention is directed to a display device characterized by a favorable pixel aperture ratio, satisfactory transmittance, and high brightness, and the display device is suitable for being applied in a head-up display.

In an embodiment of the invention, a display device that includes a display panel, an image signal input module, and a sub-pixel rendering (SPR) means is provided. The display panel includes a plurality of units, and each of the units includes at least 24 sub-pixels arranged in a plurality of columns and a plurality of rows. At least four first color sub-pixels, at least four second color sub-pixels, eight third color sub-pixels, and eight fourth color sub-pixels constitute each of the units. The image signal input module is configured to receive image signals. The SPR means is configured to perform a sub-pixel rendering process on the image signals.

In an embodiment of the invention, a head-up display includes a display module. The display module includes a light-emitting device suitable for emitting an illumination beam and the aforesaid display device, and the display panel is configured to generate an image beam.

In view of the above, each of the units in the display panel of the display device includes at least four first color sub-pixels, at least four second color sub-pixels, eight third color sub-pixels, and eight fourth color sub-pixels, and thus each of the units includes at least 24 sub-pixels arranged in a plurality of rows and a plurality of columns. Besides, the display device not only has the display panel but also has the image signal input module and the SPR means, so as to perform the sub-pixel rendering process. Compared with the conventional display device, the display device provided herein is characterized by the favorable pixel aperture ratio, the enhanced brightness of pure color and non-pure color, and favorable display quality of images.

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic block view illustrating a display device according to an embodiment of the invention.

FIG. 2A is a schematic top view illustrating a unit according to a first embodiment of the invention.

FIG. 2B is a schematic top view illustrating a variation of the unit depicted in FIG. 2A.

FIG. 3 is a schematic cross-sectional view taken along the section line I-I′ depicted in FIG. 2A according to an embodiment of the invention.

FIG. 4 is a schematic cross-sectional view taken along the section line I-I′ depicted in FIG. 2A according to another embodiment of the invention.

FIG. 5A to FIG. 5D are schematic views of defining sampling ranges of the display panel in the display device depicted in FIG. 1.

FIG. 6 is a schematic top view illustrating a unit according to a second embodiment of the invention.

FIG. 7 is a schematic top view illustrating a unit according to a third embodiment of the invention.

FIG. 8 is a schematic top view illustrating a unit according to a fourth embodiment of the invention.

FIG. 9 is a schematic top view illustrating a unit according to a fifth embodiment of the invention.

FIG. 10 is a schematic top view illustrating a unit according to a sixth embodiment of the invention.

FIG. 11 is a schematic top view illustrating a unit according to a seventh embodiment of the invention.

FIG. 12 is a schematic top view illustrating a unit according to an eighth embodiment of the invention.

FIG. 13 is a schematic top view illustrating a unit according to a ninth embodiment of the invention.

FIG. 14 is a schematic top view illustrating a unit according to a tenth embodiment of the invention.

FIG. 15 is a schematic view illustrating a head-up display according to an embodiment of the invention.

### DETAILED DESCRIPTION OF DISCLOSED EMBODIMENTS

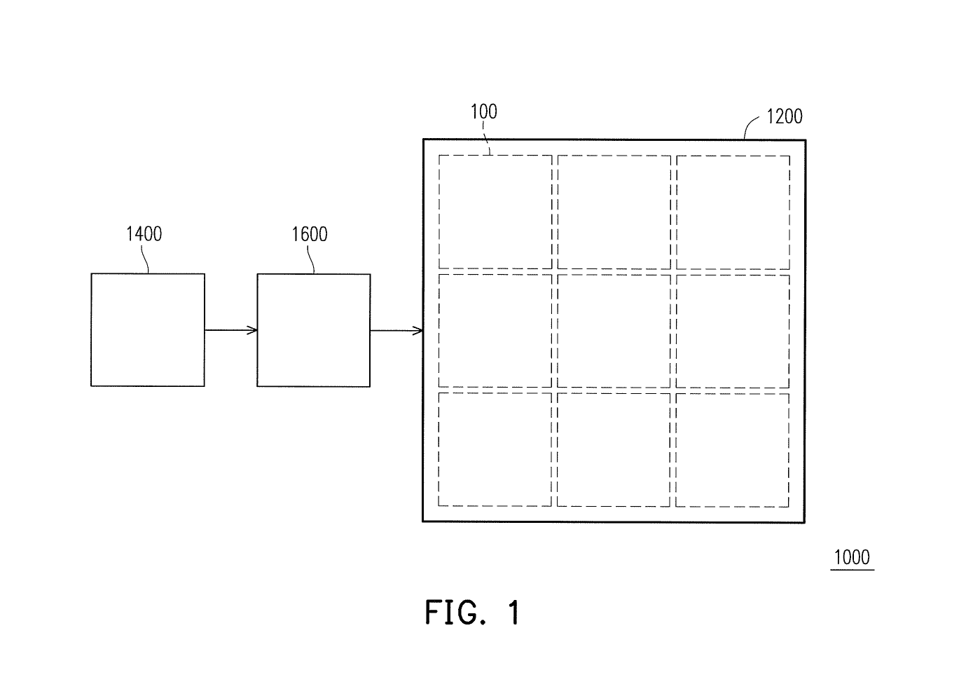

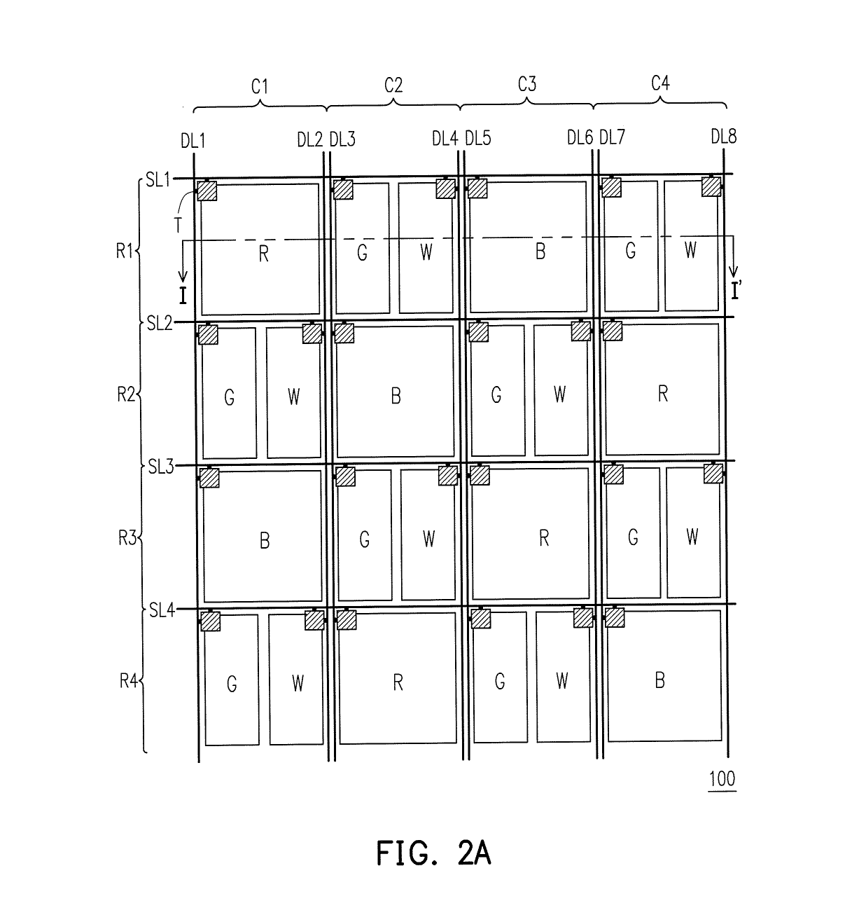

FIG. 1 is a schematic block view illustrating a display device according to an embodiment of the invention. FIG. 2A is a schematic top view illustrating a unit according to a first embodiment of the invention.

With reference to FIG. 1, a display device 1000 includes a display panel 1200, an image signal input module 1400, and a sub-pixel rendering (SPR) means 1600.

As shown in FIG. 1 and FIG. 2A, the display panel 1200 includes a plurality of units 100 arranged in an array. FIG. 1 shows nine units 100, which should however not be construed as a limitation to the invention. In another embodiment of the invention, the number of columns and rows in the array (i.e., the number of the units 100) can be adjusted according to actual design demands. Besides, for illustrative purposes, FIG. 2A merely shows one unit 100.

With reference to FIG. 2A, each of the units 100 includes 24 sub-pixels arranged in four rows R1-R4 and four columns C1-C4. Specifically, four first color sub-pixels R, four second color sub-pixels B, eight third color sub-pixels G, and eight fourth color sub-pixels W constitute each of the units 100. Each of the first color sub-pixels R, the second color sub-pixels B, the third color sub-pixels G, and the fourth color sub-pixels W respectively includes a corresponding one of scan lines SL1-SL4, a corresponding one of data lines DL1-DL8, and one switch T. The switch T is electrically connected to the corresponding one of the scan lines SL1-SL4 and the corresponding one of the data lines DL1-DL8. Besides, as shown in FIG. 2A, the data lines DL2 and DL3 are adjacent to each other, the data lines DL4 and DL5 are adjacent to each other, and the data lines DL6 and DL7 are adjacent to each other according to the present embodiment. Thereby, the display device 1000 have the favorable aperture ratio.

Although the units 100 provided in the present embodiment are implemented in form of the unit shown in FIG. 2A, the invention is not limited thereto. In another embodiment of the invention, the units 100 may also be implemented in form of the unit shown in FIG. 2B. Specifically, with reference to FIG. 2A and FIG. 2B, the difference between the unit 100 shown in FIG. 2A and the unit 100 shown in FIG. 2B lies in that the switch T of the second color sub-pixel B in the row R3 in the unit 100 shown in FIG. 2A is electrically connected to the scan line SL3 and the data line DL1, the switch T of the first color sub-pixel R in the row R3 in the unit 100 shown in FIG. 2A is electrically connected to the scan line SL3 and the data line DL5, the switch T of the first color sub-pixel R in the row R4 in the unit 100 shown in FIG. 2A is electrically connected to the scan line SL4 and the data line DL3, and the switch T of the second color sub-pixel B in the row R4 in the unit 100 shown in FIG. 2A is electrically connected to the scan line SL4 and the data line DL7. By contrast, the switch T of the second color sub-pixel B in the row R3 in the unit 100 shown in FIG. 2B is electrically connected to the scan line SL3 and the data line DL2, the switch T of the first color sub-pixel R in the row R3 in the unit 100 shown in FIG. 2B is electrically connected to the scan line SL3 and the data line DL6, the switch T of the first color sub-pixel R in the row R4 in the unit 100 shown in FIG. 2B is electrically connected to the scan line SL4 and the data line DL4, and the switch T of the second color sub-pixel B in the row R4 in the unit 100 shown in FIG. 2B is electrically connected to the scan line SL4 and the data line DL8.

Besides, the display panel 1200 is a component capable of displaying images and may be a non-self-illuminating display panel that includes a liquid crystal display (LCD), an electrophoretic display panel, an electrowetting display panel, or a self-illuminating display panel that includes an organic light-emitting diode (OLED) display panel, a plasma display panel, or a field emission display (FED) panel. Specifically, given that the display panel 1200 is the LCD, the switch T is a thin film transistor (TFT), for instance; however, the invention is not limited thereto. If the display panel 1200 is the OLED display panel, the switch T includes two TFTs and one capacitor, for instance; however, the invention is not limited thereto.

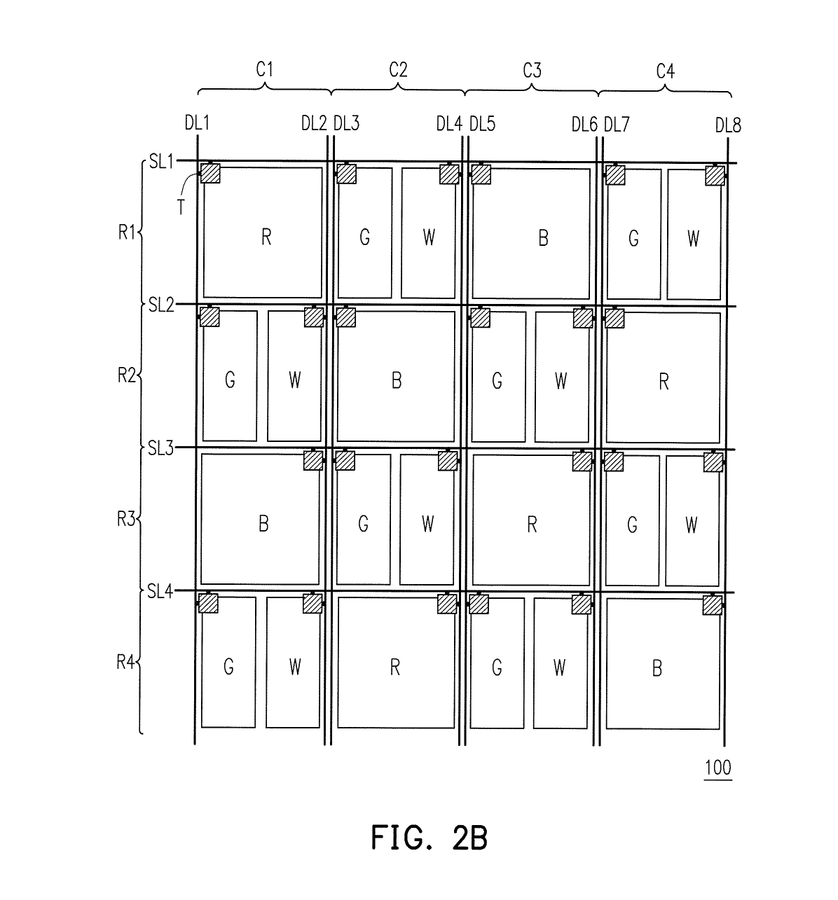

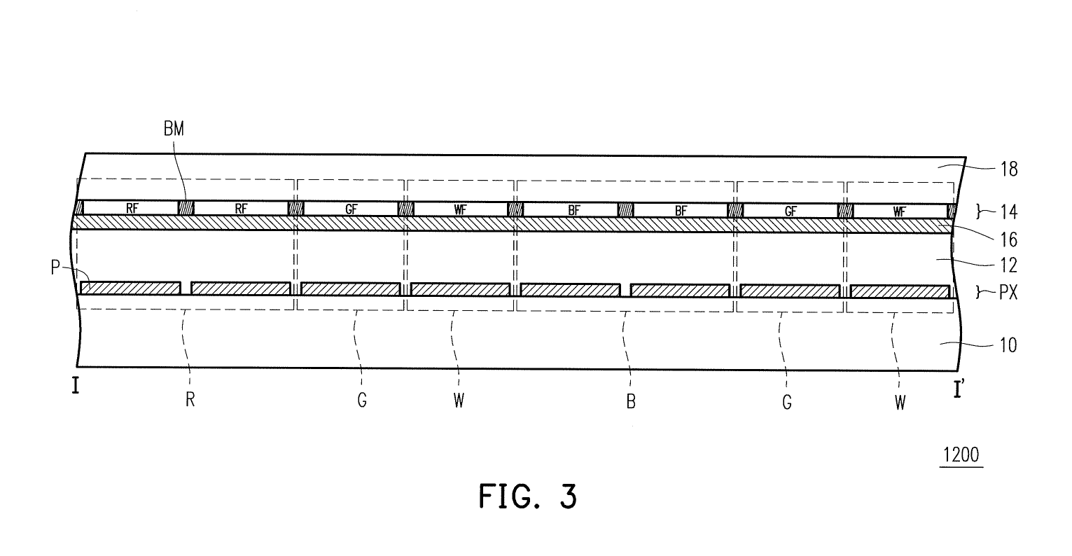

The detailed structure of the display panel 1200 is described hereinafter with reference to FIG. 3 and FIG. 4. FIG. 3 is a schematic cross-sectional view taken along the section line I-I′ depicted in FIG. 2A according to an embodiment of the invention. FIG. 4 is a schematic cross-sectional view taken along the section line I-I′ depicted in FIG. 2A according to another embodiment of the invention.

With reference to FIG. 3, the display panel 1200 includes a first substrate 10, a second substrate 18, an element layer PX, a liquid crystal layer 12, and a color filter layer 14. Specifically, in the present embodiment, the display panel 1200 is an LCD panel.

The first substrate 10 may be made of glass, quartz, organic polymer, or a non-transparent or reflective material (e.g., metal). The second substrate 18 is located opposite to the first substrate 10. The second substrate 18 may be made of glass, quartz, or organic polymer. The liquid crystal layer 12 is located between the first substrate 10 and the second substrate 18.

The color filter layer 14 is located on the second substrate 18. Nevertheless, the invention should not be construed as limited to the embodiments set forth herein. In other embodiments, the color filter layer 14 can also be located on the first substrate 10. The color filter layer 14 includes first color filter patterns RF, second color filter patterns BF, third color filter patterns GF, and fourth color filter patterns WF. Particularly, the first color filter patterns RF, the second color filter patterns BF, the third color filter patterns GF, and the fourth color filter patterns WF are red, blue, green, and white color filter patterns, respectively. Besides, the first color filter patterns RF, the second color filter patterns BF, the third color filter patterns GF, and the fourth color filter patterns WF may be any kind of filter patterns well known to people having ordinary skill in the pertinent art.

The second substrate 18 may be further equipped with a black matrix BM. The black matrix BM has openings, and the first color filter patterns RF, the second color filter patterns BF, the third color filter patterns GF, and the fourth color filter patterns WF are respectively arranged in the openings.

An electrode layer 16 may be further arranged on the second substrate 18. The electrode layer 16 is a transparent conductive layer made of metal oxide, such as indium tin oxide (ITO) or indium zinc oxide (IZO). Besides, the electrode layer 16 is located between the color filter layer 14 and the liquid crystal layer 12. In the present embodiment, the electrode layer 16 completely covers the color filter layer 14, which should however not be construed as a limitation to the invention. An electric field may be generated between the electrode layer 16 and the element layer PX, so as to control or drive the liquid crystal layer 12.

The element layer PX is located on the first substrate 10. In the present embodiment, the element layer PX is constituted by pixel structures P. Each of the pixel structures P includes a scan line, a data line, a switch, a pixel electrode, a protective layer, and so on (not shown). In particular, as shown in FIG. 2A and FIG. 3, the first color sub-pixels R include the pixel structures P and the corresponding first color filter patterns RF, the second color sub-pixels B include the pixel structures P and the corresponding second color filter patterns BF, the third color sub-pixels G include the pixel structures P and the corresponding third color filter patterns GF, and the fourth color sub-pixels W include the pixel structures P and the corresponding fourth color filter patterns WF. That is, in the present embodiment, the first color sub-pixels R, the second color sub-pixels B, the third color sub-pixels G, and the fourth color sub-pixels W are red color sub-pixels, blue color sub-pixels, green color sub-pixels, and white color sub-pixels, respectively.

FIG. 4 is a schematic cross-sectional view taken along the section line I-I′ depicted in FIG. 2A according to another embodiment of the invention. The display panel 1200 includes a first substrate 20, an element layer PX2, a first organic material layer 22, an organic light-emitting layer 24, a second organic material layer 26, and an electrode layer 28. Specifically, in the present embodiment, the display panel 1200 is an OLED display panel.

The first substrate 20 is, for instance, a glass substrate or a plastic substrate. The element layer PX2 is located on the first substrate 20. In the present embodiment, the element layer PX2 is constituted by a plurality of pixel structures P2. Each of the pixel structures P2 includes a scan line, a data line, a switch, a pixel electrode, a protective layer, and so on (not shown).

The first organic material layer 22 arranged on the first substrate 20 is at least one of a hole injection layer (HIL) and a hole transport layer (HTL), for instance. The HIL and the HTL are formed by evaporation, for instance.

The organic light-emitting layer 24 is located on the first organic material layer 22. The organic light-emitting layer 24 includes a plurality of first color organic light-emitting patterns RR, a plurality of second color organic light-emitting patterns BB, a plurality of third color organic light-emitting patterns GG, and a plurality of fourth color organic light-emitting patterns WW. Particularly, the first color organic light-emitting patterns RR, the second color organic light-emitting patterns BB, the third color organic light-emitting patterns GG, and the fourth color organic light-emitting patterns WW are red, blue, green, and white color organic light-emitting patterns, respectively. Besides, the first color organic light-emitting patterns RR, the second color organic light-emitting patterns BB, the third color organic light-emitting patterns GG, and the fourth color organic light-emitting patterns WW may be any kind of organic light-emitting patterns well known to people having ordinary skill in the pertinent art.

In particular, as shown in FIG. 2A and FIG. 4, the first color sub-pixels R include the pixel structures P2 and the corresponding first color organic light-emitting patterns RR, the second color sub-pixels B include the pixel structures P2 and the corresponding second color organic light-emitting patterns BB, the third color sub-pixels G include the pixel structures P2 and the corresponding third color organic light-emitting patterns GG, and the fourth color sub-pixels W include the pixel structures P2 and the corresponding fourth color organic light-emitting patterns WW. That is, in the present embodiment, the first color sub-pixels R, the second color sub-pixels B, the third color sub-pixels G, and the fourth color sub-pixels W are red color sub-pixels, blue color sub-pixels, green color sub-pixels, and white color sub-pixels, respectively.

The second organic material layer 26 is located on the organic light-emitting layer 24. Here, the second organic material layer 26 may be at least one of an electron transport layer (ETL) and an electron injection layer (EIL). The ETL and the EIL are forming by evaporation, for instance.

The electrode layer 28 is located on the second organic material layer 26. The material of the electrode layer 28 includes a transparent metal oxide conductive material, e.g., ITO, IZO, aluminum tin oxide (ATO), aluminum zinc oxide (AZO), indium germanium zinc oxide (IGZO), other suitable oxides, or a stacked layer having at least two of the above-mentioned materials. If necessary, a polarizer, a cover plate, or other components may be formed on the electrode layer 28 based on actual demands.

To be specific, with reference to FIG. 2A, each of the columns C1, C2, C3, and C4 in each unit 100 includes one first color sub-pixel R, one second color sub-pixel B, two third color sub-pixels G, and two fourth color sub-pixels W according to the present embodiment, and each of the rows R1, R2, R3, and R4 in each unit 100 includes one first color sub-pixel R, one second color sub-pixel B, two third color sub-pixels G, and two fourth color sub-pixels W according to the present embodiment. In the unit 100, the first color sub-pixel R, the third color sub-pixel G, the fourth color sub-pixel W, the second color sub-pixel B, the third color sub-pixel G, and the fourth color sub-pixel W are arranged sequentially from left to right in the row R1; the third color sub-pixel G, the fourth color sub-pixel W, the second color sub-pixel B, the third color sub-pixel G, the fourth color sub-pixel W, and the first color sub-pixel R are arranged sequentially from left to right in the row R2; the second color sub-pixel B, the third color sub-pixel G, the fourth color sub-pixel W, the first color sub-pixel R, the third color sub-pixel G, and the fourth color sub-pixel W are arranged sequentially from left to right in the row R3; the third color sub-pixel G, the fourth color sub-pixel W, the first color sub-pixel R, the third color sub-pixel G, the fourth color sub-pixel W, and the second color sub-pixel B are arranged sequentially from left to right in the row R4 (arrangement 1).

According to the present embodiment, the area of each of the first color sub-pixels R and the second color sub-pixels B is twice the area of each of the third color sub-pixels G and the fourth color sub-pixels W. From another perspective, in each unit 100 provided in the present embodiment, the total area of the first color sub-pixels R, the total area of the second color sub-pixels B, the total area of the third color sub-pixels G, and the total area of the fourth color sub-pixels W are equal.

Human eyes are more sensitive to green and white than to red and blue. Accordingly, the area of each of the first color sub-pixels R and the second color sub-pixels B is designed to be twice the area of each of the third color sub-pixels G and the fourth color sub-pixels W, so that display quality of the display panel 1200 can still be ensured.

With reference to FIG. 1, the image signal input module 1400 in the display device 1000 is configured to receive an image signal. The sub-pixel rendering (SPR) unit 1600 in the display device 1000 is configured to perform a sub-pixel rendering process on the image signal received by the image signal input module 1400, such that the sub-pixels (i.e., the first, second, third, and fourth color sub-pixels R, B, G, and W) of the display panel 1200 each produce a performance value. Particularly, the sub-pixel rendering process performed on the image signal includes following steps, and the first color sub-pixels R are taken for example hereinafter to describe the sub-pixel rendering process. First, sampling ranges of the first color sub-pixels R is defined. Here, each sampling range is located in a region constituted by one first color sub-pixel R and other sub-pixels adjacent to the first color sub-pixel R. Transformation matrices corresponding to the sampling ranges are obtained. According to the transformation matrices, an image signal of original pixel arrangement corresponding to the first color sub-pixels R is converted into an image signal of new pixel arrangement. That is, through the matrices transformation, the performance value generated by the display panel 100 is changed before and after the sub-pixel rendering process is performed.

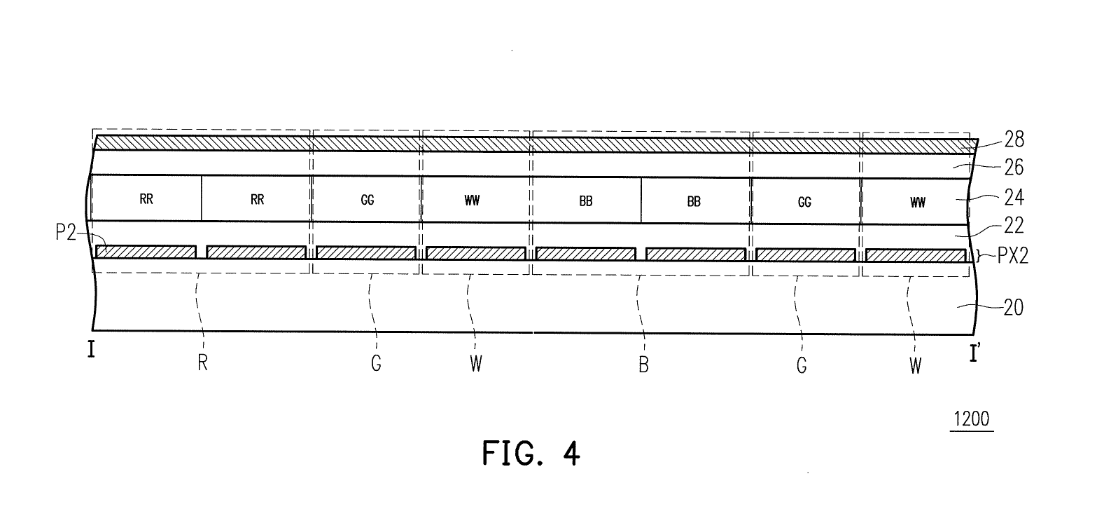

Besides, in the present embodiment, the performance value refers to the brightness, which should however not be construed as a limitation to the invention. In other embodiments, the performance value may be chroma, hue, lightness, saturation or gray level. For instance, the brightness may be greater than or equal to 0 nits, the hue may be from 0 degree to 360 degrees, the lightness may be from 0 to 100, the saturation may be greater than or equal to 0, and the gray level may be from 0 to 255. The imaging method of the display device 1000 is elaborated hereinafter with reference to FIG. 5A to FIG. 5D. FIG. 5A to FIG. 5D are schematic views of defining sampling ranges of the display panel in the display device depicted in FIG. 1.

A first step is performed, wherein the image signal input module 1400 receives image signals of first pixel arrangement (original pixel arrangement) corresponding to the first, second, third, and fourth color sub-pixels R, B, G, and W; that is, the image signal input module 1400 receives the image signal of the display panel 1200 having a specific performance value. A second step is then performed, wherein the SPR means 1600 defines the sampling ranges RS of the first color sub-pixels R, as shown in FIG. 5A. Here, each sampling range RS includes six complete sub-pixels. Particularly, each sampling range RS includes one first color sub-pixel R, one second color sub-pixel B, two third color sub-pixels G, and two fourth color sub-pixels W. A third step is performed, wherein the SPR means 1600 obtains the transformation matrices corresponding to the sampling ranges RS. In particular, the dimension of each of the transformation matrices corresponding to the sampling ranges RS is 2×2. A fourth step is performed, wherein the SPR means 1600 converts an image signal of first pixel arrangement (original pixel arrangement) corresponding to the first color sub-pixels R into an image signal of second pixel arrangement (new pixel arrangement), such that one first color sub-pixel R within each sampling range RS achieves the same effects as those accomplished by four R sub-pixels within the corresponding range in a conventional RGB display panel. That is, compared with the conventional RGB display panel, the display panel 1200 is able to display the red color (i.e., the pure color) with certain brightness.

The second, third, and fourth steps mentioned above are repeated to perform the sub-pixel rendering process on the second, third, and fourth color sub-pixels B, G, and W, respectively. As shown in FIG. 5B, each sampling range BS of the second color sub-pixels B includes six complete sub-pixels, i.e., one first color sub-pixel R, one second color sub-pixel B, two third color sub-pixels G, and two fourth color sub-pixels W. The dimension of each of the transformation matrices corresponding to the sampling ranges BS is 2×2, and after the matrices transformation, one second color sub-pixel B within each sampling range BS achieves the same effects as those accomplished by four B sub-pixels within the corresponding range in the conventional RGB display panel. As shown in FIG. 5C, the area of each sampling range GS is half the area of each sampling range RS or half the area of each sampling range BS, and each sampling range GS includes ½ first color sub-pixel R, ½ second color sub-pixel B, one third color sub-pixel G, and one fourth color sub-pixel W. The dimension of each of the transformation matrices corresponding to the sampling ranges GS is 3×3, and after the matrices transformation, one third color sub-pixel G within each sampling range GS achieves the same effects as those accomplished by two G sub-pixels within the corresponding range in the conventional RGB display panel. As shown in FIG. 5D, the area of each sampling range WS is half the area of each sampling range RS or half the area of each sampling range BS, and each sampling range WS includes ½ first color sub-pixel R, ½ second color sub-pixel B, one third color sub-pixel G, and one fourth color sub-pixel W. The dimension of each of the transformation matrices corresponding to the sampling ranges WS is 3×3, and after the matrices transformation, one fourth color sub-pixel G within each sampling range WS provides brightness larger than that provided by the conventional RGB display panel.

Finally, the first color sub-pixels R, the second color sub-pixels B, the third color sub-pixels G, and the fourth color sub-pixels W in the display panel 1200 respectively display the corresponding red, blue, green, and white performance values, i.e., a full-color image signal.

As provided above, the area of each of the R, G, and B sub-pixels in the conventional RGB display panel is smaller than the area of the first color sub-pixel R in the display panel 1200, the area of the second color sub-pixel B in the display panel 1200, the area of the third color sub-pixel G in the display panel 1200, and the area of the fourth color sub-pixel W in the display panel 1200. Thereby, the number of metal traces in the display panel 1200 can be reduced. In this way, in the display device 1000, the display panel 1200 is used in collaboration with the image signal input module 1400 and the SPR means 1600 to perform the sub-pixel rendering process, by which the pixel aperture ratio can be raised, favorable transmittance and high brightness of pure and non-pure colors can be guaranteed, and the satisfactory display quality of images can be ensured. Moreover, in the present embodiment, the display panel 1200 has the fourth color sub-pixels W (i.e., the white color sub-pixels), and thus the display panel 1200 has the increased transmittance and the enhanced brightness of non-pure color (i.e., the white color) in comparison with the conventional RGB display panel. Specifically, in the present embodiment, the transmittance of the display panel 1200 is approximately greater than 10%.

In view of the above, the area of each of the R, G, B, and W sub-pixels in a conventional RGBW display panel is smaller than the area of the first color sub-pixel R in the display panel 1200, the area of the second color sub-pixel B in the display panel 1200, the area of the third color sub-pixel G in the display panel 1200, and the area of the fourth color sub-pixel W in the display panel 1200; hence, in the display device 1000, through equipping with the image signal input signal 1400 and the SPR means 1600 to perform the sub-pixel rendering process, the issue of overly low brightness of the pure colors (i.e., red, green, and blue) in the conventional RGBW display panel can be prevented from occurring in the display panel 1200, and images can have favorable display quality.

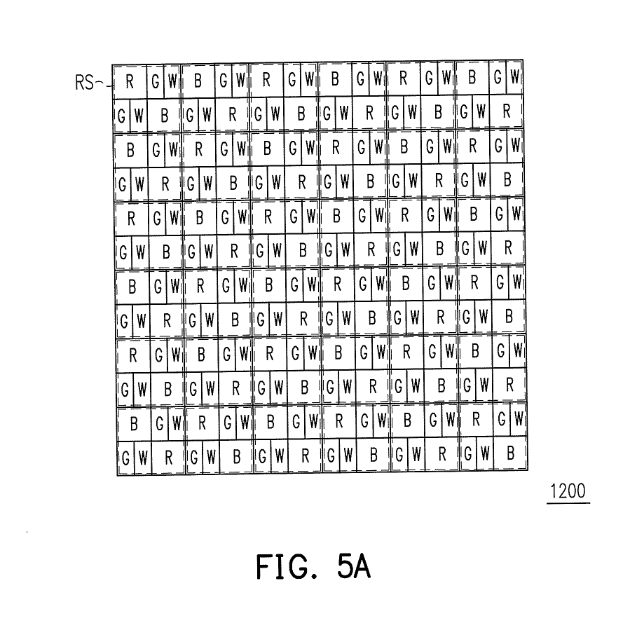

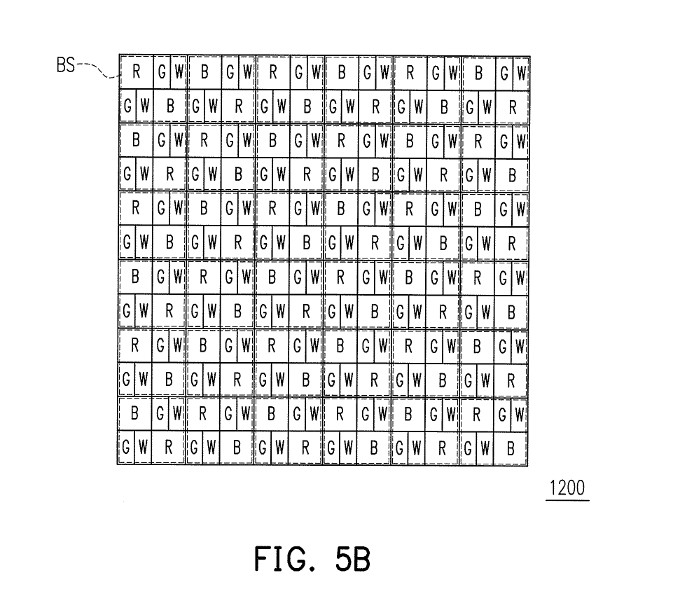

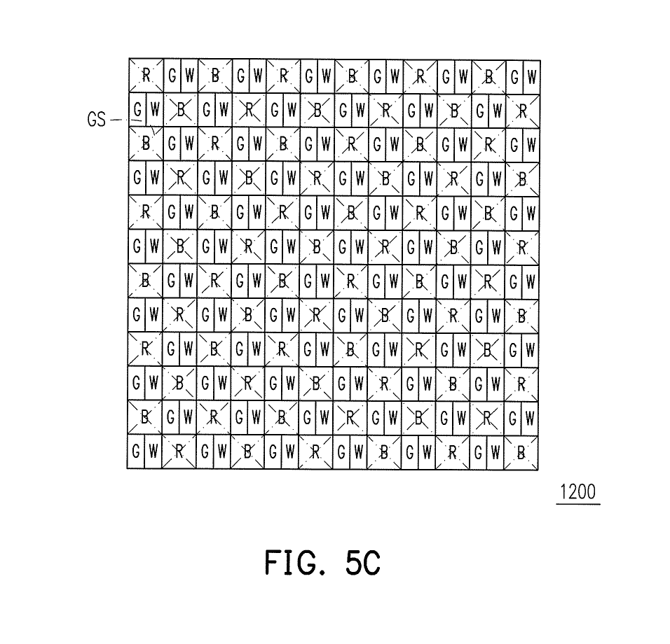

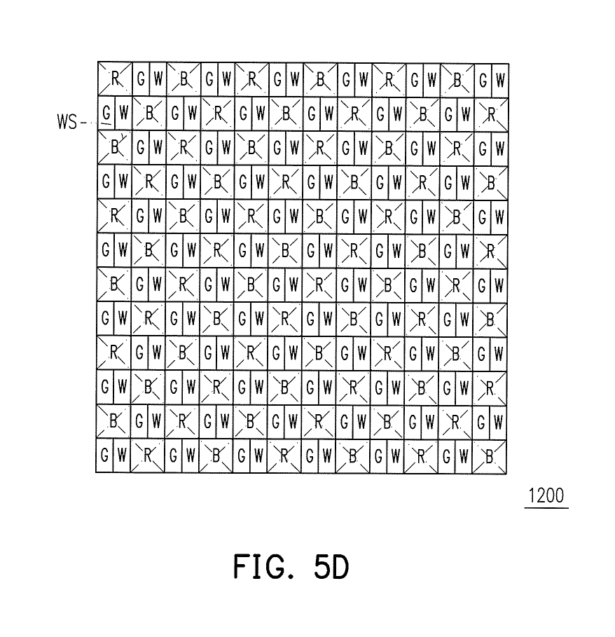

FIG. 6 is a schematic top view illustrating an unit according to a second embodiment of the invention. FIG. 7 is a schematic top view illustrating an unit according to a third embodiment of the invention. FIG. 8 is a schematic top view illustrating an unit according to a fourth embodiment of the invention. FIG. 9 is a schematic top view illustrating an unit according to a fifth embodiment of the invention. For illustrative purposes, the scan lines SL1-SL4, the data lines DL1-DL8 and the switches T are omitted in FIG. 6 to FIG. 9. Besides, the units 100a-100d depicted in FIG. 6 to FIG. 9 are similar to the unit 100 depicted in FIG. 2A; therefore, the identical or similar devices in these embodiments are represented by the identical or similar reference numbers and will not be further explained.

To be specific, with reference to FIG. 6 to FIG. 9 and FIG. 2A, the difference between the units 100a-100d depicted in FIG. 6 to FIG. 9 and the unit 100 depicted in FIG. 2A lies in the arrangements of the first, second, third, and fourth color sub-pixels R, B, G, and W. The sub-pixel arrangements of the units 100a-100d are explained hereinafter with reference to FIG. 6 to FIG. 9.

As shown in FIG. 6, each of the columns C1, C2, C3, and C4 in the unit 100a includes one first color sub-pixel R, one second color sub-pixel B, two third color sub-pixels G, and two fourth color sub-pixels W according to the present embodiment, and each of the rows R1, R2, R3, and R4 in the unit 100a includes one first color sub-pixel R, one second color sub-pixel B, two third color sub-pixels G, and two fourth color sub-pixels W according to the present embodiment. In the unit 100a, the first color sub-pixel R, the third color sub-pixel G, the fourth color sub-pixel W, the second color sub-pixel B, the third color sub-pixel G, and the fourth color sub-pixel W are arranged sequentially from left to right in the row R1; the third color sub-pixel G, the fourth color sub-pixel W, the first color sub-pixel R, the third color sub-pixel G, the fourth color sub-pixel W, and the second color sub-pixel B are arranged sequentially from left to right in the row R2; the second color sub-pixel B, the third color sub-pixel G, the fourth color sub-pixel W, the first color sub-pixel R, the third color sub-pixel G, and the fourth color sub-pixel W are arranged sequentially from left to right in the row R3; the third color sub-pixel G, the fourth color sub-pixel W, the second color sub-pixel B, the third color sub-pixel G, the fourth color sub-pixel W, and the first color sub-pixel R are arranged sequentially from left to right in the row R4 (arrangement 2).

As shown in FIG. 7, each of the odd-numbered columns C1 and C3 and the odd-numbered rows R1 and R3 in the unit 100b includes two first color sub-pixels R, two third color sub-pixels G, and two fourth color sub-pixels W according to the present embodiment; each of the even-numbered columns C2 and C4 and the even-numbered rows R2 and R4 in the unit 100b includes two second color sub-pixels B, two third color sub-pixels G, and two fourth color sub-pixels W according to the present embodiment. In the unit 100b, the first color sub-pixel R, the third color sub-pixel G, the fourth color sub-pixel W, the first color sub-pixel R, the third color sub-pixel G, and the fourth color sub-pixel W are arranged sequentially from left to right in each of the rows R1 and R3; the third color sub-pixel G, the fourth color sub-pixel W, the second color sub-pixel B, the third color sub-pixel G, the fourth color sub-pixel W, and the second color sub-pixel B are arranged sequentially from left to right in each of the rows R2 and R4 (arrangement 3).

As shown in FIG. 8, each of the columns C1, C2, C3, and C4 in the unit 100c includes one first color sub-pixel R, one second color sub-pixel B, two third color sub-pixels G, and two fourth color sub-pixels W according to the present embodiment; every two rows R1 and R2 or R3 and R4 in the unit 100c include two first color sub-pixels R, two second color sub-pixels B, four third color sub-pixels G, and four fourth color sub-pixels W according to the present embodiment. In the unit 100c, ½ first color sub-pixel R, one third color sub-pixel G, ½ second color sub-pixel B, one fourth color sub-pixel W, ½ first color sub-pixel R, one third color sub-pixel G, ½ second color sub-pixel B, and one fourth color sub-pixel W are arranged sequentially from left to right in the row R1; ½ first color sub-pixel R, one fourth color sub-pixel W, ½ second color sub-pixel B, one third color sub-pixel G, ½ first color sub-pixel R, one fourth color sub-pixel W, ½ second color sub-pixel B, and one third color sub-pixel G are arranged sequentially from left to right in the row R2; ½ second color sub-pixel B, one third color sub-pixel G, ½ first color sub-pixel R, one fourth color sub-pixel W, ½ second color sub-pixel B, one third color sub-pixel G, ½ first color sub-pixel R, and one fourth color sub-pixel W are arranged sequentially from left to right in the row R3; ½ second color sub-pixel B, one fourth color sub-pixel W, ½ first color sub-pixel R, one third color sub-pixel G, ½ second color sub-pixel B, one fourth color sub-pixel W, ½ first color sub-pixel R, and one third color sub-pixel G are arranged sequentially from left to right in the row R4 (arrangement 4).

As shown in FIG. 9, each of the columns C1, C2, C3, and C4 in the unit 100d includes one first color sub-pixel R, one second color sub-pixel B, two third color sub-pixels G, and two fourth color sub-pixels W according to the present embodiment; every two rows R1 and R2 or R3 and R4 in the unit 100d include two first color sub-pixels R, two second color sub-pixels B, four third color sub-pixels G, and four fourth color sub-pixels W according to the present embodiment. In the unit 100d, ½ first color sub-pixel R, one third color sub-pixel G, one fourth color sub-pixel W, ½ second color sub-pixel B, ½ first color sub-pixel R, one third color sub-pixel G, one fourth color sub-pixel W, and ½ second color sub-pixel B are arranged sequentially from left to right in the row R1; ½ first color sub-pixel R, one fourth color sub-pixel W, one third color sub-pixel G, ½ second color sub-pixel B, ½ first color sub-pixel R, one fourth color sub-pixel W, one third color sub-pixel G, and ½ second color sub-pixel B are arranged sequentially from left to right in the row R2; ½ second color sub-pixel B, one third color sub-pixel G, one fourth color sub-pixel W, ½ first color sub-pixel R, ½ second color sub-pixel B, one third color sub-pixel G, one fourth color sub-pixel W, and ½ first color sub-pixel R are arranged sequentially from left to right in the row R3; ½ second color sub-pixel B, one fourth color sub-pixel W, one third color sub-pixel G, ½ first color sub-pixel R, ½ second color sub-pixel B, one fourth color sub-pixel W, one third color sub-pixel G, and ½ first color sub-pixel R are arranged sequentially from left to right in the row R4 (arrangement 5).

As provided above, the area of each of the R, G, and B sub-pixels in the conventional RGB display panel is smaller than each of the area of the first color sub-pixel R, the area of the second color sub-pixel B, the area of the third color sub-pixel G, and the area of the fourth color sub-pixel W in the display panel having the unit 100a, 100b, 100c, or 100d. Thereby, the number of metal traces in each of the display panels can be reduced. In this way, after the sub-pixel rendering process is performed, the pixel aperture ratio of each of the display panels can be raised, favorable transmittance and high brightness of pure and non-pure colors can be guaranteed, and the satisfactory display quality of images can be ensured. Note that people having ordinary skill in the pertinent art should be able to derive the sub-pixel rendering method applicable to the display panel having the unit 100a, 100b, 100c, or 100d and even the sampling method from the descriptions above with reference to FIG. 1 and FIG. 5A-FIG. 5D.

Moreover, as discussed above, the display panel equipped with any of the units 100a-100d has the fourth color sub-pixels W (i.e., the white color sub-pixels), and thus each display panel provided herein has the increased transmittance and the enhanced brightness of non-pure color (i.e., the white color) in comparison with the conventional RGB display panel. Specifically, in the present embodiment, the transmittance of the display panel equipped with any of the units 100a-100d is approximately greater than 10%.

Moreover, as provided above, the area of each of the R, G, B, and W sub-pixels in a conventional RGBW display panel is smaller than each of the area of the first color sub-pixel R, the area of the second color sub-pixel B, the area of the third color sub-pixel G, and the area of the fourth color sub-pixel W in each display panel having the unit 100a, 100b, 100c, or 100d, and each display panel having the unit 100a, 100b, 100c, or 100d is used in collaboration with the image signal input module 1400 and the SPR means 1600 to perform the sub-pixel rendering process. As a result, the issue of overly low brightness of the pure colors (i.e., red, green, and blue) in the conventional RGBW display panel can be prevented from occurring in each display panel provided herein, and images can have favorable display quality.

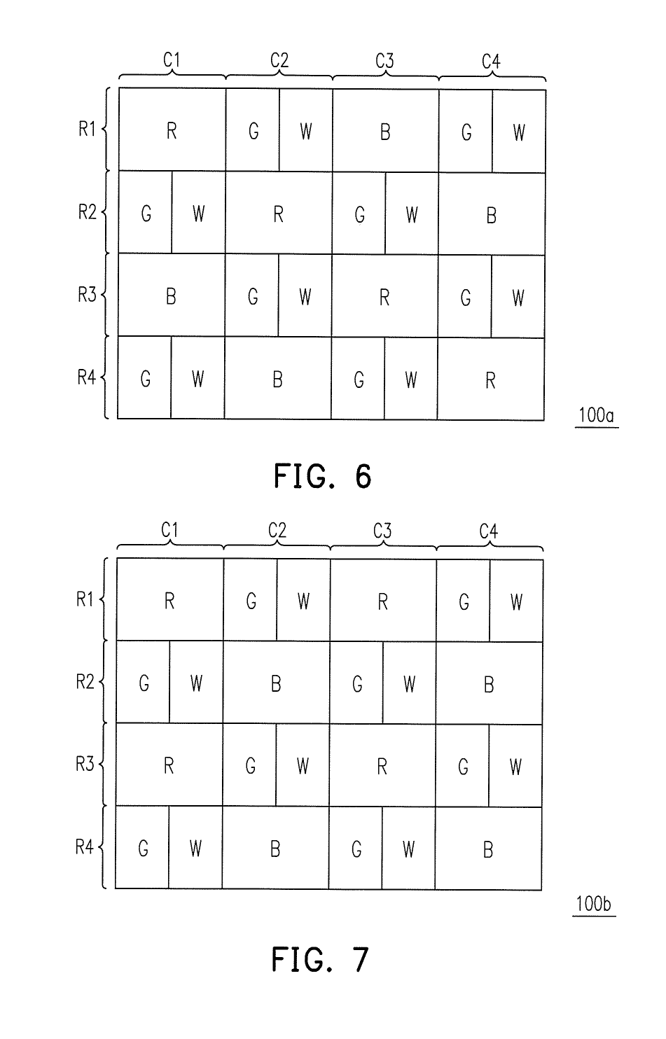

In the embodiment shown in FIG. 2A and the embodiments shown in FIG. 6 to FIG. 9, each of the units 100 and 100a-100d includes 24 sub-pixels arranged in four columns C1-C4 and four rows R1-R4. However, the invention is not limited thereto; as long as the unit includes at least 24 sub-pixels arranged in columns and rows, the unit falls within the scope of the invention. In other embodiments, the unit may include 48 sub-pixels arranged in four columns C1-C4 and four rows R1-R4. Hereafter, various embodiments of the unit will be elaborated below with reference to FIG. 10 to FIG. 14.

FIG. 10 is a schematic top view illustrating an unit according to a sixth embodiment of the invention. The unit 100e in FIG. 10 is similar to the unit 100 depicted in FIG. 2A; therefore, the identical or similar devices in these embodiments are represented by the identical or similar reference numbers and will not be further explained.

In particular, the difference between the unit 100e in FIG. 10 and the unit 100 depicted in FIG. 2A lies in that the unit 100e has eight first color sub-pixels R, eight second color sub-pixels B, eight third color sub-pixels G, and eight fourth color sub-pixels W (48 sub-pixels in total) arranged in four columns C1-C4 and four rows R1-R4, and the area of each of the first color sub-pixels R, the area of each of the second color sub-pixels B, the area of each of the third color sub-pixels G, and the area of each of the fourth color sub-pixels W are equal. By contrast, the unit 100 has four first color sub-pixels R, four second color sub-pixels B, eight third color sub-pixels G, and eight fourth color sub-pixels W (24 sub-pixels in total) arranged in four columns C1-C4 and four rows R1-R4, and the area of each of the first color sub-pixels R and the second color sub-pixels B is twice the area of each of the third color sub-pixels G and the fourth color sub-pixels W. The main difference between the two units will be elaborated hereinafter.

As shown in FIG. 10, each of the columns C1, C2, C3, and C4 in the unit 100e includes two first color sub-pixels R, two second color sub-pixels B, two third color sub-pixels G, and two fourth color sub-pixels W according to the present embodiment; each of the rows R1, R2, R3, and R4 in the unit 100e includes two first color sub-pixels R, two second color sub-pixels B, two third color sub-pixels G, and two fourth color sub-pixels W according to the present embodiment. In the unit 100e, the first color sub-pixel R, the first color sub-pixel R, the third color sub-pixel G, the fourth color sub-pixel W, the second color sub-pixel B, the second color sub-pixel B, the third color sub-pixel G, and the fourth color sub-pixel W are arranged sequentially from left to right in the row R1; the third color sub-pixel G, the fourth color sub-pixel W, the second color sub-pixel B, the second color sub-pixel B, the third color sub-pixel G, the fourth color sub-pixel W, the first color sub-pixel R, and the first color sub-pixel R are arranged sequentially from left to right in the row R2; the second color sub-pixel B, the second color sub-pixel B, the third color sub-pixel G, the fourth color sub-pixel W, the first color sub-pixel R, the first color sub-pixel R, the third color sub-pixel G, and the fourth color sub-pixel W are arranged sequentially from left to right in the row R3; the third color sub-pixel G, the fourth color sub-pixel W, the first color sub-pixel R, the first color sub-pixel R, the third color sub-pixel G, the fourth color sub-pixel W, the second color sub-pixel B, and the second color sub-pixel B are arranged sequentially from left to right in the row R4 (arrangement 6).

As provided above, the area of each of the R, G, and B sub-pixels in the conventional RGB display panel is smaller than each of the area of the first color sub-pixel R, the area of the second color sub-pixel B, the area of the third color sub-pixel G, and the area of the fourth color sub-pixel W in the display panel having the unit 100e. Thereby, the number of metal traces in such a display panel can be reduced. In this way, after the sub-pixel rendering process is performed, the pixel aperture ratio of the display panel can be raised, favorable transmittance and high brightness of pure and non-pure colors can be guaranteed, and the satisfactory display quality of images can be ensured. Note that people having ordinary skill in the pertinent art should be able to derive the sub-pixel rendering method applicable to the display panel having the unit 100e and even the sampling method from the descriptions above with reference to FIG. 1 and FIG. 5A-FIG. 5D.

Moreover, as discussed above, the display panel equipped with the unit 100e has the fourth color sub-pixels W (i.e., the white color sub-pixels), and thus such a display panel provided herein has the increased transmittance and the enhanced brightness of non-pure color (i.e., the white color) in comparison with the conventional RGB display panel. Specifically, in the present embodiment, the transmittance of the display panel equipped with the unit 100e is approximately greater than 10%.

Moreover, as provided above, the area of each of the R, G, B, and W sub-pixels in a conventional RGBW display panel is smaller than the area of the first color sub-pixel R, the area of the second color sub-pixel B, the area of the third color sub-pixel G, and the area of the fourth color sub-pixel W in the display panel having the unit 100e, and the display panel having the unit 100e is used in collaboration with the image signal input module 1400 and the SPR means 1600 to perform the sub-pixel rendering process. As a result, the issue of overly low brightness of the pure colors (i.e., red, green, and blue) in the conventional RGBW display panel can be prevented from occurring in the display panel provided herein, and images can have favorable display quality.

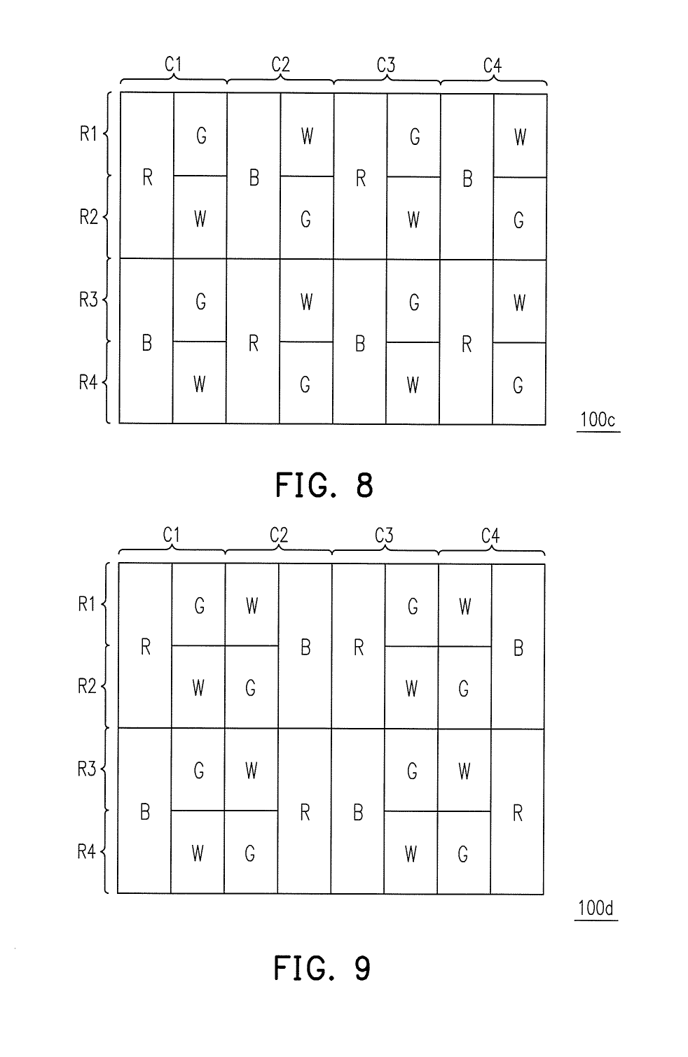

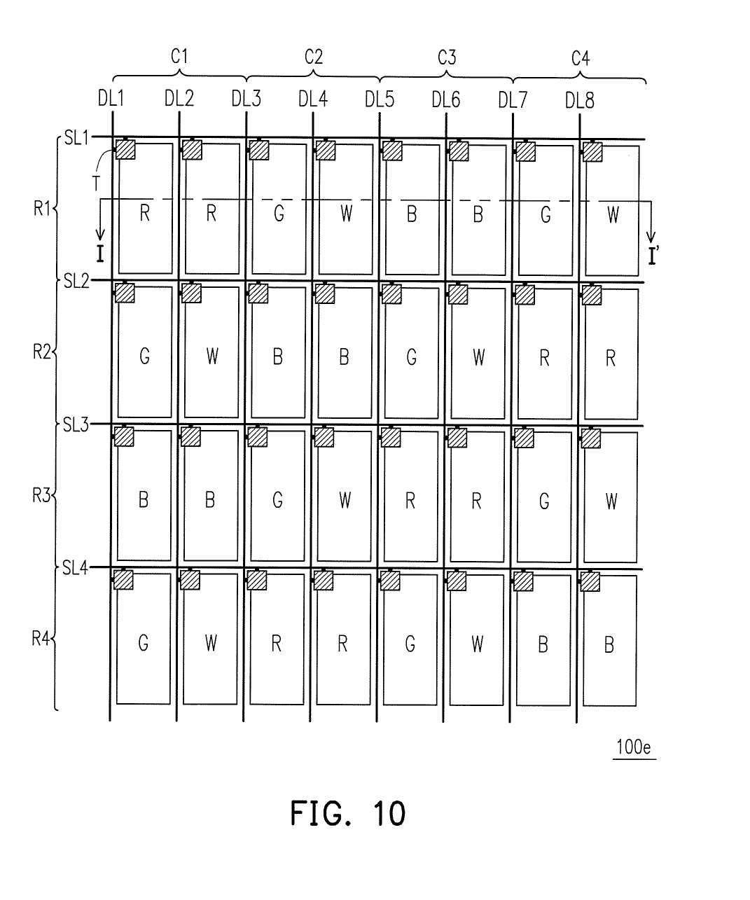

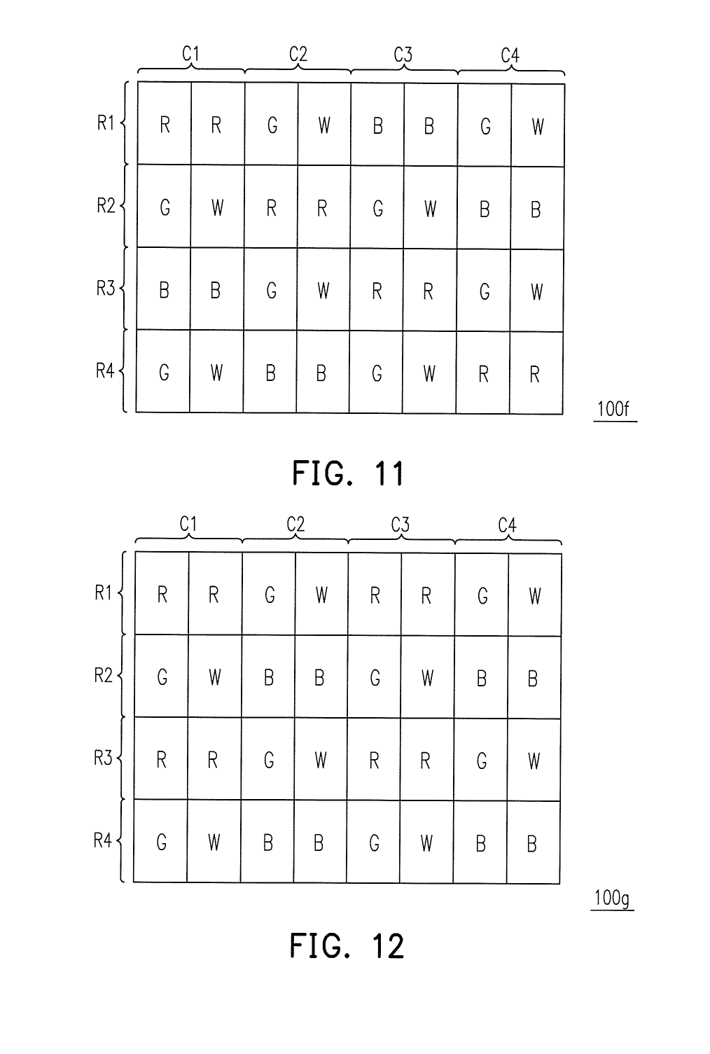

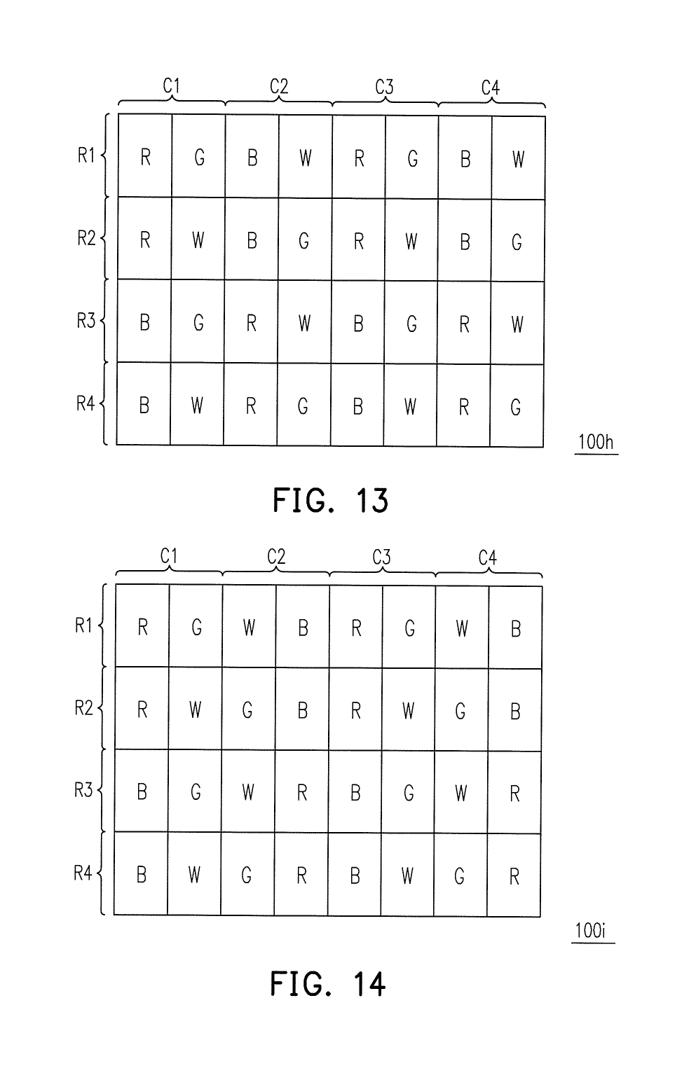

FIG. 11 is a schematic top view illustrating an unit according to a seventh embodiment of the invention. FIG. 12 is a schematic top view illustrating an unit according to an eighth embodiment of the invention. FIG. 13 is a schematic top view illustrating an unit according to a ninth embodiment of the invention. FIG. 14 is a schematic top view illustrating an unit according to a tenth embodiment of the invention. For illustrative purposes, the scan lines SL1-SL4, the data lines DL1-DL8, and the switches T are omitted in FIG. 11 to FIG. 14. Besides, the units 100f-100i depicted in FIG. 11 to FIG. 14 are similar to the unit 100e depicted in FIG. 10; therefore, the identical or similar devices in these embodiments are represented by the identical or similar reference numbers and will not be further explained.

To be specific, with reference to FIG. 11 to FIG. 14 and FIG. 10, the difference between the units 100f-100i depicted in FIG. 11 to FIG. 14 and the unit 100e depicted in FIG. 10 lies in the arrangements of the first, second, third, and fourth color sub-pixels R, B, G, and W. The sub-pixel arrangements of the units 100f-100i are explained hereinafter with reference to FIG. 11 to FIG. 14.

As shown in FIG. 11, each of the columns C1, C2, C3, and C4 in the unit 100f includes two first color sub-pixels R, two second color sub-pixels B, two third color sub-pixels G, and two fourth color sub-pixels W according to the present embodiment; each of the rows R1, R2, R3, and R4 in the unit 100f includes two first color sub-pixels R, two second color sub-pixels B, two third color sub-pixels G, and two fourth color sub-pixels W according to the present embodiment. In the unit 100f, the first color sub-pixel R, the first color sub-pixel R, the third color sub-pixel G, the fourth color sub-pixel W, the second color sub-pixel B, the second color sub-pixel B, the third color sub-pixel G and the fourth color sub-pixel W are arranged sequentially from left to right in the row R1; the third color sub-pixel G, the fourth color sub-pixel W, the first color sub-pixel R, the first color sub-pixel R, the third color sub-pixel G, the fourth color sub-pixel W, the second color sub-pixel B, and the second color sub-pixel B are arranged sequentially from left to right in the row R2; the second color sub-pixel B, the second color sub-pixel B, the third color sub-pixel G, the fourth color sub-pixel W, the first color sub-pixel R, the first color sub-pixel R, the third color sub-pixel G, and the fourth color sub-pixel W are arranged sequentially from left to right in the row R3; the third color sub-pixel G, the fourth color sub-pixel W, the second color sub-pixel B, the second color sub-pixel B, the third color sub-pixel G, the fourth color sub-pixel W, the first color sub-pixel R, and the first color sub-pixel R are arranged sequentially from left to right in the row R4 (arrangement 7).

As shown in FIG. 12, each of the odd-numbered columns C1 and C3 and the odd-numbered rows R1 and R3 in the unit 100g includes four first color sub-pixels R, two third color sub-pixels G, and two fourth color sub-pixels W according to the present embodiment; each of the even-numbered columns C2 and C4 and the even-numbered rows R2 and R4 in the unit 100g includes four second color sub-pixels B, two third color sub-pixels G, and two fourth color sub-pixels W according to the present embodiment. In the unit 100g, the first color sub-pixel R, the first color sub-pixel R, the third color sub-pixel G, the fourth color sub-pixel W, the first color sub-pixel R, the first color sub-pixel R, the third color sub-pixel G, and the fourth color sub-pixel W are arranged sequentially from left to right in each of the rows R1 and R3; the third color sub-pixel G, the fourth color sub-pixel W, the second color sub-pixel B, the second color sub-pixel B, the third color sub-pixel G, the fourth color sub-pixel W, the second color sub-pixel B, and the second color sub-pixel B are arranged sequentially from left to right in each of the rows R2 and R4 (arrangement 8).

As shown in FIG. 13, each of the columns C1, C2, C3, and C4 in the unit 100h includes two first color sub-pixels R, two second color sub-pixels B, two third color sub-pixels G, and two fourth color sub-pixels W according to the present embodiment; each of the rows R1, R2, R3, and R4 in the unit 100h includes two first color sub-pixels R, two second color sub-pixels B, two third color sub-pixels G, and two fourth color sub-pixels W according to the present embodiment. In the unit 100h, the first color sub-pixel R, the third color sub-pixel G, the second color sub-pixel B, the fourth color sub-pixel W, the first color sub-pixel R, the third color sub-pixel G, the second color sub-pixel B, and the fourth color sub-pixel W are arranged sequentially from left to right in the row R1; the first color sub-pixel R, the fourth color sub-pixel W, the second color sub-pixel B, the third color sub-pixel G, the first color sub-pixel R, the fourth color sub-pixel W, the second color sub-pixel B, and the third color sub-pixel G are arranged sequentially from left to right in the row R2; the second color sub-pixel B, the third color sub-pixel G, the first color sub-pixel R, the fourth color sub-pixel W, the second color sub-pixel B, the third color sub-pixel G, the first color sub-pixel R, and the fourth color sub-pixel W are arranged sequentially from left to right in the row R3; the second color sub-pixel B, the fourth color sub-pixel W, the first color sub-pixel R, the third color sub-pixel G, the second color sub-pixel B, the fourth color sub-pixel W, the first color sub-pixel R, and the third color sub-pixel G are arranged sequentially from left to right in the row R4 (arrangement 9).

As shown in FIG. 14, each of the columns C1, C2, C3, and C4 in the unit 100i includes two first color sub-pixels R, two second color sub-pixels B, two third color sub-pixels G, and two fourth color sub-pixels W according to the present embodiment; each of the rows R1, R2, R3, and R4 in the unit 100i includes two first color sub-pixels R, two second color sub-pixels B, two third color sub-pixels G, and two fourth color sub-pixels W according to the present embodiment. In the unit 100i, the first color sub-pixel R, the third color sub-pixel G, the fourth color sub-pixel W, the second color sub-pixel B, the first color sub-pixel R, the third color sub-pixel G, the fourth color sub-pixel W, and the second color sub-pixel B are arranged sequentially from left to right in the row R1; the first color sub-pixel R, the fourth color sub-pixel W, the third color sub-pixel G, the second color sub-pixel B, the first color sub-pixel R, the fourth color sub-pixel W, the third color sub-pixel G, and the second color sub-pixel B are arranged sequentially from left to right in the row R2; the second color sub-pixel B, the third color sub-pixel G, the fourth color sub-pixel W, the first color sub-pixel R, the second color sub-pixel B, the third color sub-pixel G, the fourth color sub-pixel W, and the first color sub-pixel R are arranged sequentially from left to right in the row R3; the second color sub-pixel B, the fourth color sub-pixel W, the third color sub-pixel G, the first color sub-pixel R, the second color sub-pixel B, the fourth color sub-pixel W, the third color sub-pixel G, and the first color sub-pixel R are arranged sequentially from left to right in the row R4 (arrangement 10).

As provided above, the area of each of the R, G, and B sub-pixels in the conventional RGB display panel is smaller than the area of the first color sub-pixel R, the area of the second color sub-pixel B, the area of the third color sub-pixel G, and the area of the fourth color sub-pixel W in the display panel having the unit 100f, 100g, 100h, or 100i. Thereby, the number of metal traces in each display panel can be reduced. In this way, after the sub-pixel rendering process is performed, the pixel aperture ratio of each of the display panels can be raised, favorable transmittance and high brightness of pure and non-pure colors can be guaranteed, and the satisfactory display quality of images can be ensured. Note that people having ordinary skill in the pertinent art should be able to derive the sub-pixel rendering method applicable to the display panel having the unit 100f, 100g, 100h, or 100i and even the sampling method from the descriptions above with reference to FIG. 1 and FIG. 5A-FIG. 5D.

Moreover, as discussed above, the display panel equipped with the unit 100f, 100g, 100h, or 100i has the fourth color sub-pixels W (i.e., the white color sub-pixels), and thus such a display panel provided herein has the increased transmittance and the enhanced brightness of non-pure color (i.e., the white color) in comparison with the conventional RGB display panel. Specifically, in the present embodiment, the transmittance of the display panel equipped with the unit 100f, 100g, 100h, or 100i is approximately greater than 10%.

Moreover, as provided above, the area of each of the R, G, B, and W sub-pixels in a conventional RGBW display panel is smaller than the area of the first color sub-pixel R, the area of the second color sub-pixel B, the area of the third color sub-pixel G, and the area of the fourth color sub-pixel W in each display panel having any of the units 100f-100i, and each display panel having any of the units 100f-100i is used in collaboration with the image signal input module 1400 and the SPR means 1600 to perform the sub-pixel rendering process. As a result, the issue of overly low brightness of the pure colors (i.e., red, green, and blue) in the conventional RGBW display panel can be prevented from occurring in each display panel provided herein, and images can have favorable display quality.

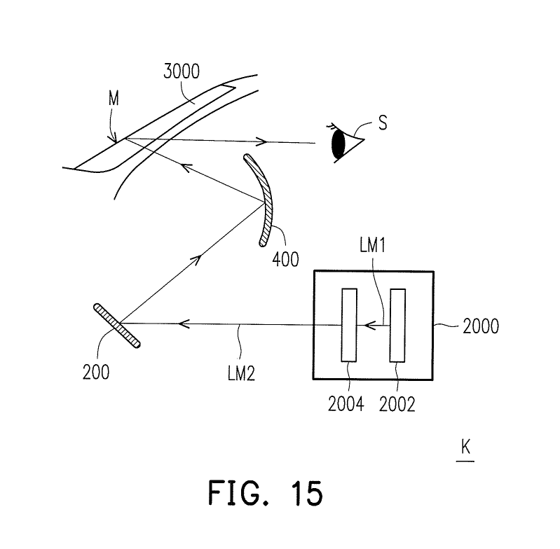

FIG. 15 is a schematic view illustrating a head-up display according to an embodiment of the invention. With reference to FIG. 15, the head-up display K is arranged below a wind-shielding transparent component 3000 of a means of transport. In the present embodiment, the means of transport is a vehicle, and the wind-shielding transparent component 3000 is the windshield in front of a driver, for instance. However, the invention is not limited thereto, and the means of transport in other embodiments may be a train, an airplane, a ship, a submarine, or any other types of the means of transport. The wind-shielding transparent component 3000 may be the window next to the passengers or a transparent screen arranged at other locations.

Specifically, the head-up display K includes a display module 2000. The display module 2000 includes a light-emitting device 2002 and a display device 2004. An illumination beam LM1 emitted from the light-emitting device 2002 may pass through the display device 2004 and may then be converted into an image beam LM2 according to the present embodiment. The image beam LM2 may be projected onto the wind-shielding transparent component 3000 of the means of transport, so as to generate an image M for a user S to observe.

Besides, the head-up display K may alternatively include an optical component 200 arranged on a transmission path of the image beam LM2. In the present embodiment, the optical component 200 is, for instance, a planar reflective mirror. Particularly, the optical component 200 is able to change the transmission direction of the image beam LM2; thereby, the image beam LM2 is transmitted to the wind-shielding transparent component 3000, and an image is then generated. The head-up display K may alternatively include another optical component 400 arranged on a transmission path of the image beam LM2 coming from the optical component 200. In the present embodiment, the optical component 400 is, for instance, a curved reflective mirror. Specifically, the optical component 400 can further change the transmission direction of the image beam LM2 and increase the length of the transmission path of the image beam LM2 to increase the size of the image M. Furthermore, the optical component 400 also compensates for aberration of the image M on the curved wind-shielding transparent component 3000, such that the user S is able to observe the image with favorable imaging quality. However, the invention is not limited thereto, and the head-up display in other embodiments of the invention may be equipped with plural optical components. For instance, the optical path of the head-up display may be constituted by two or three reflective optical components and one lens component.

In the present embodiment, the display device 2004 may be implemented in form of the display device 1000 or the display device having any of the units 100a-100i of the embodiments. To be specific, in the present embodiment, the display device 2004 is implemented in form of the display device 1000 in which the display panel 1200 is the non-self-illuminating display panel (as shown in FIG. 3) or the display device in which the display panel having any of the units 100a-100i is the non-self-illuminating display panel. Thereby, the display device 2004 can be characterized by the favorable transmittance and can display the image M with satisfactory display quality as well as high brightness and even high brightness of pure colors. In addition, the increasing transmittance of the display device 2004 leads to the reduction of the power consumption of the backlight plate of the display device 2004, and thus the overall power consumption of the head-up display K is reduced.

Although the display module 2000 of the head-up display K includes the light-emitting device 2002 and the display device 2004, the invention is not limited thereto. In another embodiment of the invention, the display module of the head-up display may merely include the display device. In this case, the display device may be implemented in form of the display device 1000 in which the display panel 1200 is the self-illuminating display panel (as shown in FIG. 4) or the display device in which the display panel having any of the units 100a-100i of the embodiments is the self-illuminating display panel.

To sum up, each of the units in the display panel of the display device includes at least four first color sub-pixels, at least four second color sub-pixels, eight third color sub-pixels, and eight fourth color sub-pixels, and thus each of the units includes at least 24 sub-pixels arranged in a plurality of rows and a plurality of columns. Besides, the display device not only has the display panel but also has the image signal input module and the SPR means, so as to perform the sub-pixel rendering process. In this way, compared with the conventional display device, the display device provided herein is characterized by the favorable pixel aperture ratio, the enhanced brightness of pure color and non-pure color, and favorable display quality of images.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A display device comprising:
a display panel comprising a plurality of units, each of the units comprising at least 24 sub-pixels arranged in a plurality of rows and a plurality of columns, wherein at least four first color sub-pixels, at least four second color sub-pixels, eight third color sub-pixels, and eight fourth color sub-pixels constitute each of the units;
an image signal input module configured to receive an image signal; and
a sub-pixel rendering means configured to conduct a sub-pixel rendering process on the image signal.

2. The display device of claim 1, wherein an area of each of the first color sub-pixels and the second color sub-pixels is twice an area of each of the third color sub-pixels and the fourth color sub-pixels.

3. The display device of claim 2, wherein the sub-pixels in each of the columns comprise one of the first color sub-pixels, one of the second color sub-pixels, two of the third color sub-pixels, and two of the fourth color sub-pixels, and the sub-pixels in each of the rows comprise one of the first color sub-pixels, one of the second color sub-pixels, two of the third color sub-pixels, and two of the fourth color sub-pixels.

4. The display device of claim 2, wherein the sub-pixels in each of the odd-numbered columns and odd-numbered rows comprise two of the first color sub-pixels, two of the third color sub-pixels, and two of the fourth color sub-pixels, and the sub-pixels in each of the even-numbered columns and even-numbered rows comprise two of the second color sub-pixels, two of the third color sub-pixels, and two of the fourth color sub-pixels.

5. The display device of claim 2, wherein the sub-pixels in each of the columns comprise one of the first color sub-pixels, one of the second color sub-pixels, two of the third color sub-pixels, and two of the fourth color sub-pixels, and the sub-pixels in every two of the rows comprise two of the first color sub-pixels, two of the second color sub-pixels, four of the third color sub-pixels, and four of the fourth color sub-pixels.

6. The display device of claim 1, wherein the sub-pixels in each of the columns comprise one of the first color sub-pixels, one of the second color sub-pixels, two of the third color sub-pixels, and two of the fourth color sub-pixels, and the sub-pixels in each of the rows comprise one of the first color sub-pixels, one of the second color sub-pixels, two of the third color sub-pixels, and two of the fourth color sub-pixels.

7. The display device of claim 1, wherein the sub-pixels in each of the odd-numbered columns and odd-numbered rows comprise two of the first color sub-pixels, two of the third color sub-pixels, and two of the fourth color sub-pixels, and the sub-pixels in each of the even-numbered columns and even-numbered rows comprise two of the second color sub-pixels, two of the third color sub-pixels, and two of the fourth color sub-pixels.

8. The display device of claim 1, wherein the sub-pixels in each of the columns comprise one of the first color sub-pixels, one of the second color sub-pixels, two of the third color sub-pixels, and two of the fourth color sub-pixels, and the sub-pixels in every two of the rows comprise two of the first color sub-pixels, two of the second color sub-pixels, four of the third color sub-pixels, and four of the fourth color sub-pixels.

9. The display device of claim 1, wherein the 24 sub-pixels in each of the units have one of following arrangements: 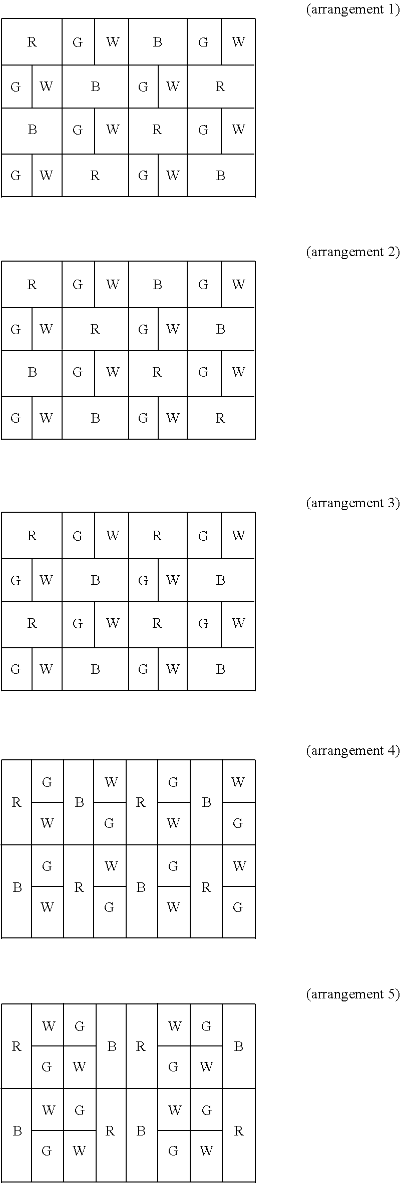
wherein R is the first color sub-pixel, B is the second color sub-pixel, G is the third color sub-pixel, and W is the fourth color sub-pixel.

10. The display device of claim 1, wherein an area of each of the first color sub-pixels, an area of each of the second color sub-pixels, an area of each of the third color sub-pixels, and an area of each of the fourth color sub-pixels are equal.

11. The display device of claim 10, wherein the sub-pixels in each of the columns comprise two of the first color sub-pixels, two of the second color sub-pixels, two of the third color sub-pixels, and two of the fourth color sub-pixels, and the sub-pixels in each of the rows comprise two of the first color sub-pixels, two of the second color sub-pixels, two of the third color sub-pixels, and two of the fourth color sub-pixels.

12. The display device of claim 10, wherein the sub-pixels in each of the odd-numbered columns and odd-numbered rows comprise four of the first color sub-pixels, two of the third color sub-pixels, and two of the fourth color sub-pixels, and the sub-pixels in each of the even-numbered columns and even-numbered rows comprise four of the second color sub-pixels, two of the third color sub-pixels, and two of the fourth color sub-pixels.

13. The display device of claim 1, wherein the 32 sub-pixels in each of the units have one of following arrangements: 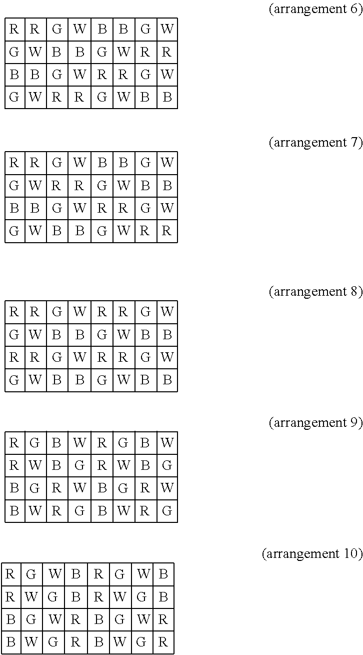
wherein R is the first color sub-pixel, B is the second color sub-pixel, G is the third color sub-pixel, and W is the fourth color sub-pixel.

14. The display device of claim 1, wherein the sub-pixels in each of the columns comprise two of the first color sub-pixels, two of the second color sub-pixels, two of the third color sub-pixels, and two of the fourth color sub-pixels, and the sub-pixels in each of the rows comprise two of the first color sub-pixels, two of the second color sub-pixels, two of the third color sub-pixels, and two of the fourth color sub-pixels.

15. The display device of claim 1, wherein the sub-pixels in each of the odd-numbered columns and odd-numbered rows comprise four of the first color sub-pixels, two of the third color sub-pixels, and two of the fourth color sub-pixels, and the sub-pixels in each of the even-numbered columns and even-numbered rows comprise four of the second color sub-pixels, two of the third color sub-pixels, and two of the fourth color sub-pixels.

16. The display device of claim 1, wherein the sub-pixel rendering process is conducted thereby each of the sub-pixels produce a performance value including brightness, chroma, hue, lightness, saturation or gray level.

17. The display device of claim 1, wherein a total area of the first color sub-pixels, a total area of the second color sub-pixels, a total area of the third color sub-pixels, and a total area of the fourth color sub-pixels in each of the units are equal.

18. A head-up display comprising:
a display module comprising:
a light-emitting device suitable for emitting an illumination beam; and
the display device of claim 1, wherein the display panel is configured to generate an image beam.
